(19) United States
(12) Patent Application Publication
(10) Pub. No.: US 2025/0362137 A1
(43) Pub. Date: Nov. 27, 2025

(54) METHOD FOR DETERMINING OPTIMAL ROUTE BY USE OF LARGE NEIGHBORHOOD SEARCH

(71) Applicant: CIEL MOBILITY INC., Daegu (KR)

(72) Inventors: Mu Youl PARK, Daegu (KR); Joonkoo KANG, Daegu (KR)

(21) Appl. No.: 19/006,903

(22) Filed: Dec. 31, 2024

(30) Foreign Application Priority Data
May 22, 2024 (KR) 10-2024-0066318
Dec. 31, 2024 (KR) 10-2024-0201583

(51) Int. Cl. G01C 21/34

(52) U.S. Cl. CPC G01C 21/3446; G01C 21/3461; G01C 21/3469

(57) ABSTRACT

A method for calculating an optimal route includes selecting first and second optimization targets; distributing optimal route calculation of the first and second optimization targets to first and second thread modules, respectively; calculating a cost matrix between nodes or receiving the cost matrix from a database when calculating an optimal route according to the LNS by applying the first and second optimization targets; randomly arranging nodes of a starting point, an arrival point and stopovers, and executing the optimal route calculation according to the LNS based on the cost matrix between the arranged nodes; and selecting an optimal route that satisfies a predetermined condition according to the first and second optimization targets calculated in the optimal route calculation. The optimal route calculation is executed by updating the cost matrix between two nodes connected by destruction and repair of the LNS into a cost matrix corresponding to the optimization target.

### CROSS-REFERENCE TO RELATED APPLICATIONS

This application claims priority from Korean Application No. 10-2024-0201583 filed Dec. 31, 2024 and Korean Application No. 10-2024-0066318 filed May 22, 2024, which are incorporated herein by reference in their entireties.

### TECHNICAL FIELD

The present disclosure relates to a method for calculating an optimal route using Large Neighborhood Search (hereinafter referred to as “LNS”), and more specifically, to a method for calculating an optimized route with respect to cost and time, which have a reciprocal relationship in a multiple node-to-node path.

### RELATED ART

There are several path optimization algorithms for selecting the optimal route with the lowest cost (such as expense and time) in a route with multiple nodes, but as the number of nodes increases, the number of possible combinations increases exponentially, resulting in a problem that takes a very long time to find the optimized route.

Among the optimization algorithms, the LNS method is an algorithm that finds the optimal solution through a Destroy-Repair process. There are several methods for deletion and restoration, and even in the same type of deletion, the range of searching for the optimal value may vary depending on which node is deleted.

According to the prior art, it was possible to calculate the optimal route in the case where the cost and time change linearly together, but there was a limitation in that it was not possible to calculate the optimal route in the case where the cost and time change in an inversely proportional relationship.

In addition, the prior art's optimal route search can only find an optimal route that meets specific conditions, for example, minimum cost or minimum distance, when there are a fixed number of waypoints between the starting point and the destination, and there is a limitation that various conditions cannot be applied for each section.

### SUMMARY

The present disclosure aims to provide a method for calculating an optimal route using LNS for multiple paths in which cost and time vary in an inversely proportional relationship.

The present disclosure relates to an electronic computing device implemented method for calculating an optimal route among a plurality of routes including nodes, which comprises a first step of selecting first and second optimization targets to be applied to the optimal route calculation according to LNS, the first and second optimization target being different each other; a second step of distributing the optimal route calculation of the first optimization target to the first thread module, and the optimal route calculation of the second optimization target to the second thread module; a third step of calculating a cost matrix between nodes or receiving the cost matrix from a database when calculating an optimal route according to LNS by applying the first and second optimization targets; a fourth step of randomly arranging nodes of the starting point, the arrival point and the stopovers, and executing optimal route calculation according to LNS based on the cost matrix between the arranged nodes; and a fifth step of selecting an optimal route that satisfies a predetermined condition among different optimal routes according to the first optimization target and the second optimization target calculated in the fourth step, as a final optimal route.

The fourth step is a step of executing optimal route calculation according to LNS, by updating the cost matrix between the two nodes connected by destruction and repair of LNS into a cost matrix corresponding to the optimization target.

The first optimization target is minimum time and the second optimization target is shortest distance. The cost matrix can be a matrix including cost information generated during movement between nodes when determined by each optimization target.

The cost information can be at least one of fuel consumption, carbon emissions, electricity consumption of an electric vehicle, and fare information.

The first thread module and the second thread module can comprise a plurality of sub-thread modules, respectively. Each of the sub-thread modules performs the LNS operation according to different preconditions in the LNS operation; and the first thread module and the second thread module respectively output optimal routes calculated through the LNS operation by the plurality of sub-thread modules based on the different preconditions.

The method of the present disclosure can be executed by a computer program recorded on a computer-readable recording medium.

According to the present disclosure, there is provided an effect of being able to calculate an optimal route using LNS for cost and time that change in an inversely proportional relationship.

### BRIEF DESCRIPTION OF THE DRAWINGS

FIG. 1 is a block diagram of a system in which the present disclosure is implemented.

FIG. 2 is a flow chart of an optimal path calculation method according to the present disclosure.

FIG. 3 is a diagram showing nodes and paths to explain optimal path calculation according to the present disclosure.

FIG. 4 is a flow chart of a sub-execution method by a sub-thread module according to another embodiment of the present disclosure.

### DETAILED DESCRIPTION

Hereinafter, the present disclosure will be described in detail with reference to the accompanying drawings.

The information (data) transmission/reception process performed in this specification may be encrypted/decrypted as needed, and in this specification and the claims, expressions describing the information (data) transmission process should be interpreted as including all cases of encryption/decryption even if not specifically mentioned.

In this specification, expressions in the form of “transmission (delivery) from A to B” or “A receives from B” include transmission (delivery) or reception including other media in the middle, and do not express only direct transmission (delivery) or reception from A to B. In the description of the present disclosure, the order of each step should be understood as non-limiting unless the preceding step must be performed logically and temporally before the subsequent step. That is, except for the above exceptional cases, even if the process described as a subsequent step is performed before the process described as a preceding step, the essence of the invention is not affected and the scope of rights should also be defined regardless of the order of steps.

In this specification, “A or B” is defined to mean not only selectively referring to either one of A and B but also including both A and B. In addition, in this specification, the term “comprise” or “include” has a meaning that encompasses not only the listed elements as included but also further including other constituent elements.

In this specification, only the minimum constituent elements necessary for the description of the present disclosure are described, and constituent elements unrelated to the essence of the present disclosure are not mentioned. And it should not be interpreted as an exclusive meaning including only the constituent elements mentioned, but should be interpreted as a non-exclusive meaning that can include other constituent elements not mentioned.

In this specification, “module” or “unit” or “˜part” or “node” means a logical combination of general-purpose hardware and software that performs its functions.

The expressions “first”, “second” or similar expressions used in this specification are used to distinctively express the same or similar constituent elements or to distinguish the names of constituent elements or steps constituting the present disclosure, and do not mean order or mean plurality.

The method according to the present disclosure may be executed by an electronic computing device such as a computer, tablet PC, mobile phone, portable computing device, fixed computing device, or the like. In addition, it should be understood that one or more methods or forms of the present disclosure may be executed by at least one processor. The processor may be installed in a computer, tablet PC, mobile device, portable computing device, or the like. A memory configured to store computer program instructions is installed in such a device, and the processor is specifically programmed to execute the program instructions stored in the program to execute one or more processes as described herein. Further, it should be understood that the information, methods, etc. described in this specification may be executed by a computer, tablet PC, mobile device, portable computing device, or the like including one or more additional constituent elements and processors. In addition, the control logic may be implemented as a non-transitory computer-readable medium including program instructions executable by a processor, control unit/control unit, or the like. Examples of computer-readable media include, but are not limited to, ROM, RAM, CD-ROM, magnetic tape, floppy disk, flash drive, smart card, optical data storage device, and the like. Further, the computer-readable recording medium may be distributed in a computer connected through a network, and may be stored and executed in a distributed manner, for example, in a distributed manner by a remote server or cloud.

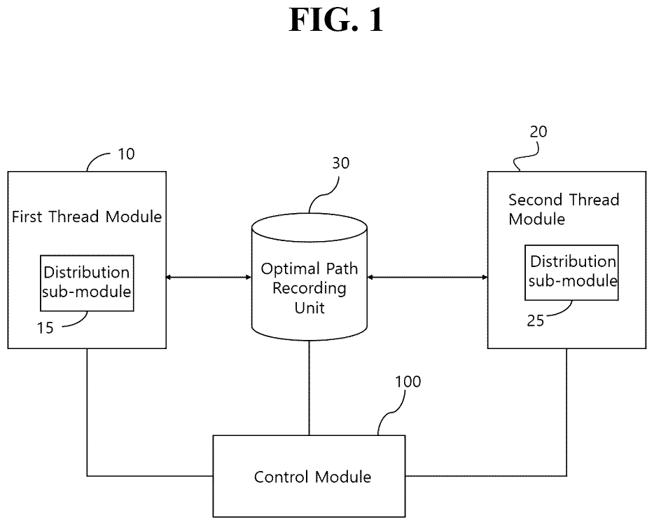

FIG. 1 shows a block diagram of a system in which the present disclosure is implemented.

As shown in FIG. 1, the system of the present disclosure includes a control module (100), a first thread module (10), a second thread module (20), and an optimal path recording unit (30) in which the calculated optimal path is recorded.

The first thread module (10) includes a distribution sub-module (15). The first thread module (10) and the second thread module (20) perform path optimization calculation according to the LNS algorithm to calculate an optimal path. The distribution sub-module (15) plays a role of distributing optimization tasks according to different conditions to the first thread module (10) and the second thread module (20). The optimization task is calculating the optimal path according to Destroy-Repair of the LNS algorithm. A plurality of second thread modules (20) may be provided.

The control module (100) is a module that controls the entire optimal path calculation using LNS according to the present disclosure. The control module (100) controls the execution of the first thread module (10) and the second thread module (20), and the execution of a sub-thread module, which will be described later. Although the control module (100) is shown as a separate component in FIG. 1, the control module (100) may be integrated with the first thread module (10).

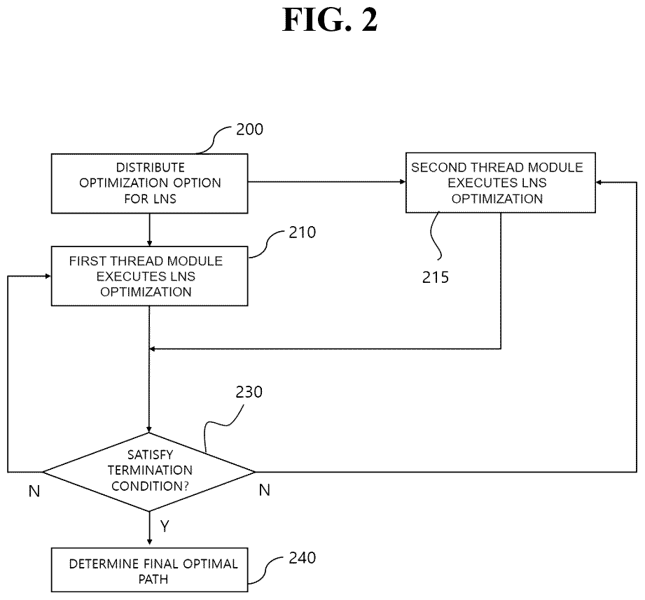

FIG. 2 shows a flow chart of the optimal path calculation using LNS according to the present disclosure.

In this specification, the cost may be fuel consumption, carbon emissions, battery consumption in the case of an electric vehicle, fare in the case of paid transportation means such as a taxi, and the like.

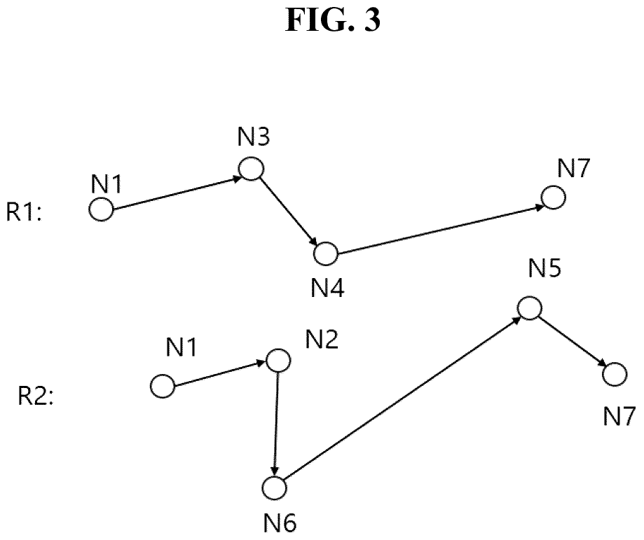

In step (200), the control module (100) distributes optimization options for LNS. The optimization option is for what value to be optimized, which will be described with reference to FIG. 3.

The optimal path is calculated among the paths that connect a starting node (N1) and an arrival node (N7).

Nodes (N2, N3, N4, N5, N6) are intermediate stopovers and are subject to Destroy/Repair of LNS.

Initially, Path 1 (R1) is assumed to be a path consisting of node (N1)-[c_1]-node (N3)-[c_2]-node (N4)-[c_2]-node (N7). Path 2 (R2) is assumed to be a path consisting of node (N1)-[c_2]-node (N2)-[c_1]-node (N6)-[c_1]-node (N5)-[c_2]-node (N8).

According to the prior art, the cost, time, distance, etc. between nodes is fixed, or even if the time changes, it is optimized based on the fixed state as a single value at a specific time. However, in the present disclosure, the cost, time, and distance between nodes are not fixed, and the optimal path can be searched by combining multiple paths and various conditions.

The example in this specification is an embodiment in which the optimization method of the present disclosure is executed using path_1, which is an optimized path based on the minimum time between nodes, and path_2, which is an optimized path based on the minimum distance. Although this is not always the case, path_1 may have a longer distance than path_2, and path_2 may take longer travel time than path_1, and more conditions (for example, carbon emissions, electricity consumption in electric vehicles, etc.) for searching for an optimal path can be applied.

[c_?] indicated between the nodes means a cost (including time) matrix used when following the optimization conditions applied between the nodes. When the optimization of the above-mentioned path_1 condition is applied between nodes, the cost (travel distance, fuel consumption, carbon emission, electricity consumption, etc.) matrix of path_1 according to the movement between nodes is denoted as c_1, and when the optimization of the above-mentioned path_2 condition is applied between nodes, the cost matrix of path_2 according to the movement between nodes is denoted as c_2.

In this specification, it is assumed that the first thread module (10) performs optimization using c_1, and the second thread module (20) performs optimization using c_2. According to the present disclosure, even when optimizing Path 1 (R1) with the shortest time, that is, path_1, it is possible to optimize by considering other costs, for example, other factors such as carbon emissions. In the above-mentioned initial path, the cost matrix between nodes is not set only to c_1, but c_1 and c_2 are arbitrarily given conditions, and then c_1 can be used for optimization as described later.

Let's consider a case where the first thread module (10) destroys node (N3) and node (N5) for optimal path calculation by LNS.

Since the first thread module (10) performs optimization based on path_1, the path is changed as follows by the destruction:
R1: Node (N1)-[c_1]-Node (N4)-[c_2]-Node (N7)
R2: Node (N1)-[c_2]-Node (N2)-[c_1]-Node (N6)-[c_1]-Node (N7)

The constraints (e.g., time) between the newly connected nodes by the destruction are updated with c_1, which is the cost matrix of path_1.

After the destruction, it is assumed that node (N5) is inserted between node (N4) and node (N7), and node (N3) is inserted between node (N6) and node (N7) by repair. The path is changed as follows by this repair:
R1: Node (N1)-[c_1]-Node (N4)-[c_1]-Node (N5)-[c_1]-Node (N7)
R2: Node (N2)-[c_2]-Node (N2)-[c_1]-Node (N6)-[c_1]-Node (N3)-[c_1]-Node (N7)

The constraints (e.g., time) between the newly connected nodes by the insertion are updated with c_1, which is the cost matrix of path_1.

In step (215), the second thread module (20) performs optimization with c_2.

Let's consider a case where the second thread module (20) destroys node (N4) and node (N6) for optimal path calculation by LNS.

Since the second thread module (20) performs optimization with c_2, the path is changed as follows by the destruction:
R1: Node (N1)-[c_1]-Node (N3)-[c_2]-Node (N7)
R2: Node (N1)-[c_2]-Node (N2)-[c_2]-Node (N5)-[c_1]-Node (N7)

The constraints (e.g., time) between the newly connected nodes by the insertion are updated with c_2, which is the cost matrix of path_2.

After the destruction, it is assumed that node (N6) is inserted between node (N3) and node (N7), and node (N4) is inserted between node (N2) and node (N5) by repair. The path is changed as follows by this repair:
R1: Node (N1)-[c_1]-Node (N3)-[c_2]-Node (N6)-[c_2]-Node (N7)
R2: Node (N1)-[c_2]-Node (N2)-[c_2]-Node (N4)-[c_2]-Node (N5)-[c_1]-Node (N7)

The constraints (e.g., time) between the newly connected nodes by the insertion are updated with c_2, which is the cost matrix of path_2.

In step (230), it is determined whether the optimal path calculated in step (210) and the optimal path calculated in step (215) meet the termination conditions, and if not, the process returns to step (210) and step (215) to execute the LNS optimization described above. If it is determined that the termination conditions are met, the corresponding path is determined as the final optimal path (step 240).

The respective optimization processes executed by the first thread module (10) and the second thread module (20) can be executed in parallel by the sub-thread modules of each thread module.

The first thread module (10) and the second thread module each include distribution sub-modules (15, 25). The distribution sub-module (15) can distribute the Destroy-Repair, as described below, to the 1-1 sub-thread module and the 1-2 sub-thread module according to the preconditions. The distribution sub-module (25) can distribute the Destroy-Repair, as described below, to the 2-1 sub-thread module and the 2-2 sub-thread module according to the preconditions. The illustration of the sub-thread modules is omitted for simplification of the drawing.

Three or more sub-thread modules may be provided depending on the number of precondition sets.

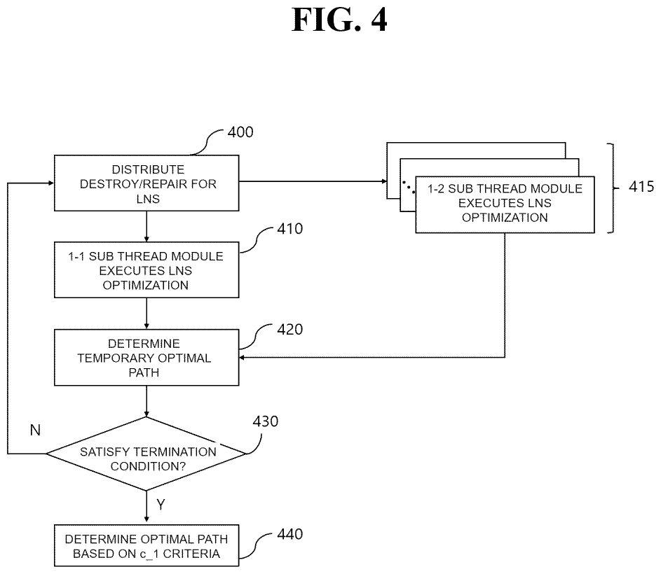

FIG. 4 shows a flow chart of the process in which optimal path calculation is performed with different preconditions by the sub-thread modules of each thread module. The following algorithm is a general algorithm for optimal path calculation using LNS.

| | |
|---|---|
| 1: | input: a feasible solution x |
| 2: | x^{b} = x; |
| 3: | repeat |
| 4: | x^{t} = r(d(x)); |
| 5: | if accept(x^{t},x) then |
| 6: | x = x^{t}; |
| 7: | end if |
| 8: | if c(x^{t}) < c(x^{b}) then |
| 9: | x^{b} = x^{t}; |
| 10: | end if |
| 11: | until stopping criterion is met |
| 12: | return x^{b} |

x^{b} represents the best solution, x represents the current solution, x^{t} represents a temporary solution, function d(·) represents the destruction method, and function r(·) represents the repair method.

There is various precondition information such as a Destroy-Repair method (algorithm), a random variable which is determined to select a node to be destroyed, and an accept method for accepting an optimization calculation result. The sub-thread modules search different search ranges according to the precondition information.

In the method according to the present embodiment, in calculating the optimal path according to each optimization condition (path_1 or path_2), a plurality of precondition information sets for each optimal path calculation are determined and the LNS optimal path calculation using some of the plurality of precondition information sets is performed by one sub-thread module, and the LNS optimal path calculation using the remaining precondition information sets are performed by another sub-thread module. Each precondition set is composed of preconditions necessary for optimal path calculation by LNS.

In step (400), the distribution sub-modules (15, 25) distribute the Destroy/Repair tasks for LNS according to the precondition sets. That is, one sub-thread module executes the optimal path calculation operation according to LNS based on some of the plurality of set precondition sets, and the other sub-thread module distributes the optimal path calculation operation according to the remaining precondition sets. If a plurality of sub-thread modules are provided, the remaining precondition sets can be divided and distributed.

Each sub-thread module performs the LNS optimization operation according to the designated preconditions (steps 410 and 415).

Referring to FIG. 4, the optimal paths calculated by the 1-1 sub-thread module and the 1-2 sub-thread module are compared in step (420), and then a temporary optimal path is determined.

In step (430), the control module (100) determines whether the temporary optimal path determined in step (420) meets the termination conditions. If it does not meet the termination conditions, the process returns to step (400) and repeats the above-described processes.

According to this embodiment, since each sub-thread module performs calculating the optimal path according to the LNS algorithm with different precondition sets of Destroy-Repair, it is possible to find the optimal path independently without overlapping search ranges. Therefore, it is possible to quickly calculate the optimal path without duplicate areas, thereby shortening the time and improving the efficiency of the calculation.

Although the present disclosure has been described with reference to the accompanying drawings, the scope of the present disclosure is determined 1 by the claims described below and should not be construed as being limited to the foregoing embodiments and/or drawings. And it is clearly understood that improvements, changes, and modifications of the invention described in the claims, which are obvious to those skilled in the art, are also included in the scope of the present disclosure.

1. An electronic computing device implemented method for calculating an optimal route among a plurality of routes including nodes, comprising:
a first step of selecting first and second optimization targets to be applied to optimal route calculation according to Large Neighborhood Search (LNS), the first and second optimization target being different from each other;
a second step of distributing the optimal route calculation of the first optimization target to a first thread module, and the optimal route calculation of the second optimization target to a second thread module;
a third step of calculating a cost matrix between nodes or receiving the cost matrix from a database when calculating an optimal route according to the LNS by applying the first and second optimization targets;
a fourth step of randomly arranging nodes of a starting point, an arrival point and stopovers, and executing the optimal route calculation according to the LNS based on the cost matrix between the arranged nodes;
a fifth step of selecting an optimal route that satisfies a predetermined condition among different optimal routes according to the first optimization target and the second optimization target calculated in the fourth step, as a final optimal route;
wherein the fourth step is a step of executing the optimal route calculation according to the LNS, by updating the cost matrix between two nodes connected by destruction and repair of the LNS into a cost matrix corresponding to the optimization target.

2. The method of claim 1, wherein the first optimization target is minimum time and the second optimization target is minimum distance, and the cost matrix is a matrix including cost information generated during movement between nodes when determined by each optimization target.

3. The method of claim 2, wherein the cost information is at least one of fuel consumption, carbon emissions, electricity consumption of an electric vehicle, and or fare information.

4. The method of claim 1, wherein the first thread module and the second thread module comprise a plurality of sub-thread modules, respectively; wherein each of the sub-thread modules performs the LNS operation according to different preconditions in the LNS operation; and wherein the first thread module and the second thread module respectively output optimal routes calculated through the LNS operation by the plurality of sub-thread modules based on the different preconditions.

5. A computer program recorded on a non-transitory computer-readable recording medium for executing the method of claim 1.

6. A non-transitory computer-readable recording medium where a computer program for executing the method of claim 1 is recorded.
